(19) United States
(12) Patent Application Publication
(10) Pub. No.: US 2026/0094912 A1
(43) Pub. Date: Apr. 2, 2026

(54) BATTERY

(71) Applicant: HONDA MOTOR CO., LTD., Tokyo (JP)

(72) Inventors: Yuya Tabuchi, Tokyo (JP); Jyunichiro Abe, Tokyo (JP); Shoji Nitta, Tokyo (JP); Atsuhiro Higashino, Tokyo (JP)

(21) Appl. No.: 19/340,912

(22) Filed: Sep. 26, 2025

(30) Foreign Application Priority Data
Sep. 30, 2024 (JP) 2024-171361

(51) Int. Cl. H01M 50/244; H01M 50/213

(52) U.S. Cl. CPC H01M 50/244; H01M 50/213

(57) ABSTRACT

This battery includes a cell and a cell holder having a plurality of housing portions for housing the cell, in which the housing portion has a bottom portion abutting one end of the cell and a wall surrounding a periphery of the cell, and the wall has a formed bulge that is continuous with the bottom portion and bulges to an inside of the housing portion to abut against a side wall of the cell.

### CROSS-REFERENCE TO RELATED APPLICATION

The present application claims priority based on Japanese Patent Application No. 2024-171361, filed September 30, 2024, the content of which is incorporated herein by reference.

### BACKGROUND OF THE INVENTION

### Field of the Invention

The present invention relates to a battery.

### Description of Related Art

In recent years, research and development has been conducted into batteries that contribute to energy efficiency to ensure that more people have access to affordable, reliable, sustainable and advanced energy.

For example, a battery provided with a honeycomb insulation board that is hexagonal in shape when viewed from above and houses cells inside, and a fixing block for fixing the cells inside the honeycomb insulation board is known (for example, refer to Chinese Patent Application, Publication No. 107275715). Hereinafter, the honeycomb insulation board may be referred to as a “cell holder.”

### SUMMARY OF THE INVENTION

However, in the technology relating to batteries, a fixing block is provided near a middle of the cell holder in a longitudinal direction. For this reason, when a cell holder is molded, it is necessary to provide a fixing block inside the cell holder, making it difficult to mold the cell holder.

The present invention aims to solve the problems described above by providing a cell holder that can be easily molded. Thereby, it may contribute to the improvement of energy efficiency.

To achieve the object described above, a battery according to an aspect of the present invention has adopted the following configuration.

(1) According to an aspect of the present invention, a battery includes a cell (for example, a cell 32 in the embodiment) and a cell holder (for example, a first cell holder unit 31, a second sell holder unit 42 in the embodiment) having a plurality of housing portions (for example, housing portions 37 in the embodiment) for housing the cell, in which the housing portion has a bottom portion (for example, a first bottom portion 53 in the embodiment) abutting one end (for example, a first end portion 32a in the embodiment) of the cell and a wall (for example, a wall 58 in the embodiment) surrounding a periphery of the cell, and the wall has a formed bulge (for example, a first bulge 62 in the embodiment) that is continuous with the bottom portion and bulges to an inside of the housing portion to abut against a side wall of the cell.

According to the aspect (1) described above, the bulge is formed (provided), which is continuous with the bottom portion of the housing portion. The bulge bulges to the inside of the housing portion to abut against the side wall of the cell. Here, for example, the housing portion is divided in the axial direction, and an opening portion is provided on the opposite side to the bulge. Therefore, for example, the mold can be closed and opened in the axial direction based on the bulge, and the bulge can be easily molded on a wall of the housing portion. This makes it possible to easily mold the cell holder.

(2) In the aspect of (1) described above, the cell holder may have a recessed portion (for example, a recessed portion 64 in the embodiment) recessed from a bottom portion side to an inside of the housing portion, and the bulge may be formed of a surface exposed to an inside of the housing portion corresponding to the recessed portion.

According to the aspect (2) described above, the bulge is exposed to the inside of the housing portion corresponding to the recessed portion recessed from the bottom portion side to the inside of the housing portion. Therefore, the thickness of the bulge can be made thin. As a result, the bulge can be deformed to match the shape of the cell when the cell is inserted toward the bulge in the housing portion. Therefore, the bulge can hold the cell with an appropriate pressure.

(3) In the aspect of (2) described above, a thickness of the bulge may be thinner than a thickness of the bottom portion and a portion of the wall other than the bulge.

According to the aspect (3) described above, the thickness of the bulge is made thinner than the bottom portion and the wall. Therefore, when the cell is inserted toward the bulge in the housing portion, the bulge can be deformed more easily. As a result. the bulge can hold the cell with more appropriate pressure.

(4) In the aspect of (1) described above, the cell may be cylindrical, the wall may have a polygonal shape when viewed in a direction orthogonal to the bottom portion, the bulge may be formed at an intersection (for example, an intersection 59 in the embodiment) where the wall intersects, and a portion of the wall other than the bulge may be separated from a side wall of the cell.

According to the aspect (4) described above, the bulge is formed at the intersection where the wall of the housing portion intersects, and a portion of the wall other than the bulge is separated from the side wall of the cell. Therefore, in the wall of the housing portion, an air layer can be secured between the portion other than the bulge and the side wall of the cell. As a result, a portion of the side wall of the cell that does not abut against the bulge can be brought to be adjacent to an adjacent housing portion via the air layer. Therefore, it is possible to prevent heat generated in the cell from being transmitted to the adjacent housing portion.

(5) In the aspect of (1) described above, the bulge may have a vertical portion (for example, vertical portions 65 and 67 in the embodiment) extending in a substantially perpendicular direction from the bottom portion, and an inclined portion (for example, inclined portions 66 and 68 in the embodiment) that connects from the vertical portion to a portion of the wall other than the bulge and has a surface inclined with respect to the vertical portion.

According to the aspect (5) described above, the bulge has an inclined portion, which is set to a surface inclined with respect to the vertical portion. Therefore, when a cell is inserted toward the bulge in the housing portion, the cell can be moved to the inside of the vertical portion while being abutted against (being brought into contact with) the inclined portion. This makes it possible to easily insert a cell into the housing portion while preventing the cell from strongly interfering with the bulge.

According to the aspects of the present invention, the purpose is to make it easy to mold the cell holder.

### BRIEF DESCRIPTION OF THE DRAWINGS

FIG. 1 is a perspective view of a battery in an embodiment of the present invention.

FIG. 2 is an exploded perspective view which shows the battery of FIG. 1.

FIG. 3 is a cross-sectional view taken along line III-III in FIG. 2.

FIG. 4 is a cross-sectional view of a first battery module in the embodiment.

FIG. 5 is a perspective view which shows the first battery module in the embodiment when it is attached to a bottom case.

FIG. 6 is a perspective view of a second cell holder of a first cell holder unit in the embodiment, viewed from above.

FIG. 7 is a bottom view which shows the second cell holder of the first cell holder unit in the embodiment.

FIG. 8 is a bottom view which shows an enlarged view of VIII in the second cell holder of FIG. 7.

### DESCRIPTION OF EMBODIMENTS

Hereinafter, a battery according to one embodiment of the present invention will be described with reference to the drawings.

### Battery

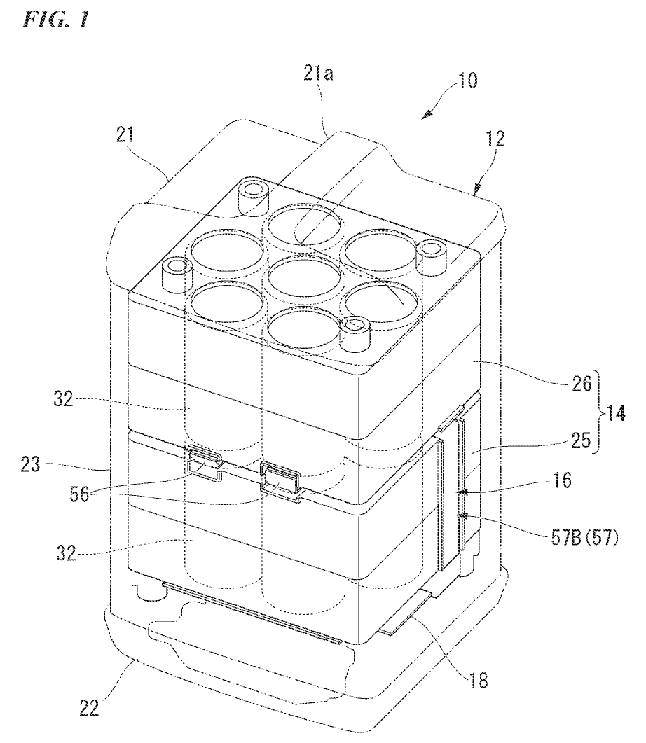

FIG. 1 is a perspective view of a battery according to the embodiment.

As shown in FIG. 1, the battery 10 is configured to be detachable from, for example, various electric power devices. The electric power devices from which the battery 10 is detachable include, for example, electric vehicles, electric mobile objects, electric machines, power supply devices, and various electric devices. The electric vehicles include, for example, electric cars equipped with a rotating electric machine driven by power of the battery 10 as a power source, saddle-type vehicles, and kick scooters, hybrid vehicles that combine a rotating electric machine and an internal combustion engine, and fuel battery vehicles that combine the battery 10 and a fuel battery. The electric mobile objects include, for example, robots, aircraft, and mobile objects on and under water. The electric machines are, for example, construction machines equipped with a rotating electric machine as a power source. The power supply device is, for example, a stationary or mobile power supply device that discharges and charges the battery 10.

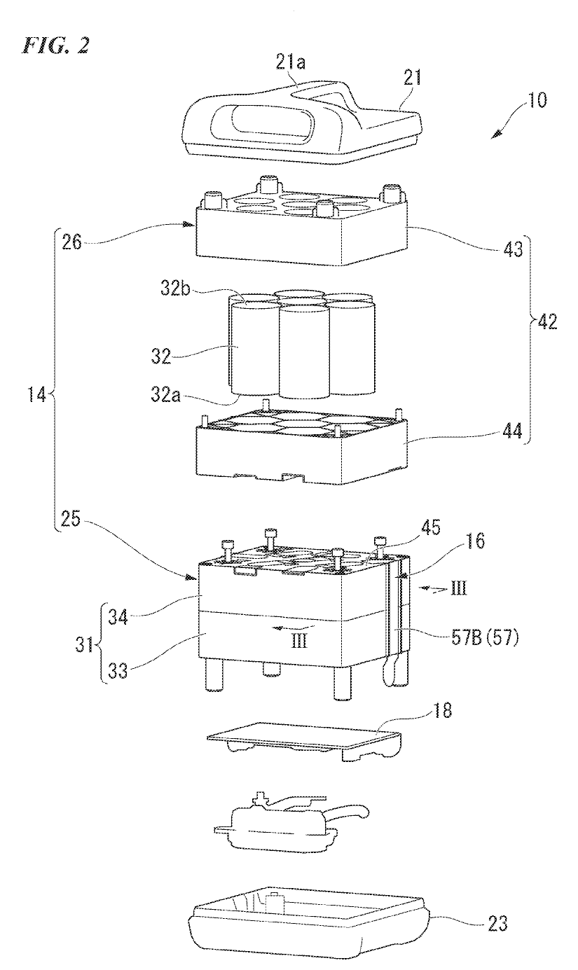

FIG. 2 is an exploded perspective view which shows the battery in FIG. 1.

As shown in FIGS. 1 and 2, an outer shape of the battery 10 is, for example, a box-like shape with a handle 21a on a top case 21 which will be described below. The battery 10 is a so-called cassette-type battery pack (secondary battery) that is configured to be replaceable. The battery 10 includes, for example, a battery case 12, a battery module unit 14, a bus bar unit 16, and a control unit 18.

### Battery case

The battery case 12 includes the top case 21, a bottom case 22, and a middle case 23. An outer shape of each of the top case 21 and the bottom case 22 is, for example, an open box shape. An outer shape of the middle case 23 is, for example, a cylindrical shape. The top case 21 and the bottom case 22 close both open end portions in an axial direction along a central axis of the middle case 23.

In the following, a top case 21 side of the battery 10 will be described as an “upper side” and a bottom case 22 side as a “lower side.” A direction of a surface orthogonal to a vertical direction will be described as a “planar direction.” The vertical direction may also be referred to as an “orthogonal direction” orthogonal to the planar direction.

In the embodiment, an orientation of the battery 10 will be described using the top case 21 on the upper side and the bottom case 22 on the lower side, but the orientation of the battery 10 can be selected arbitrarily.

### Battery module unit

The battery module unit 14 is disposed inside the battery case 12 (specifically, the middle case 23). The battery module unit 14 includes, for example, a first battery module 25 and a second battery module 26.

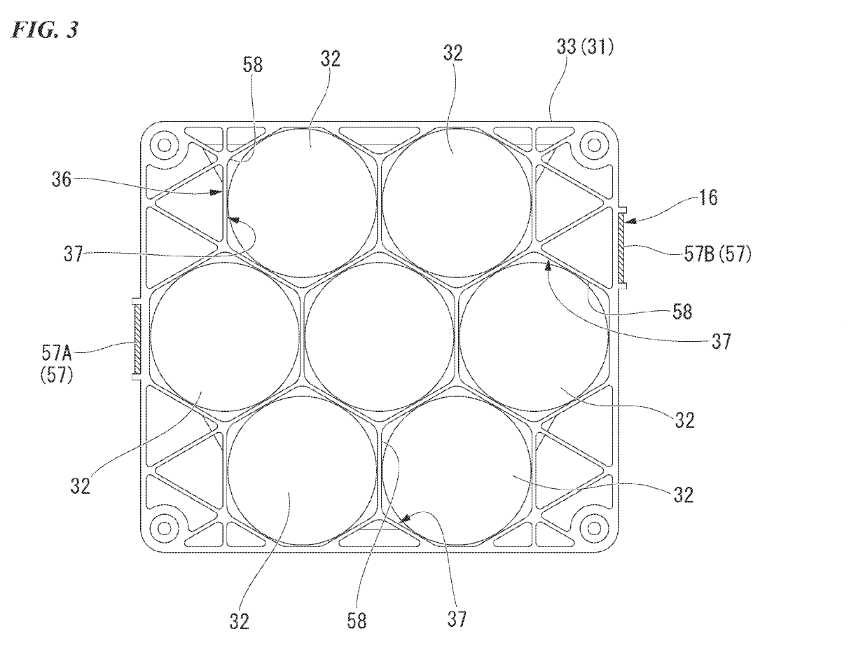

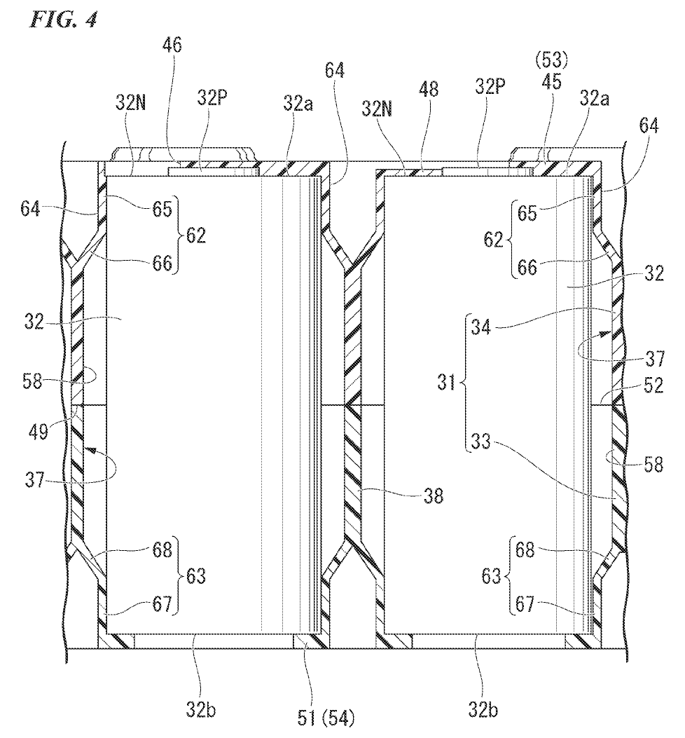

FIG. 3 is a cross-sectional view taken along line III-III in FIG. 2. FIG. 4 is a cross-sectional view of the first battery module.

As shown in FIGS. 2 to 4, the first battery module 25 includes, for example, a first cell holder unit (cell holder) 31 and a plurality of cells 32. The first cell holder unit 31 includes a first cell holder 33 and a second cell holder 34. In the first cell holder unit 31, the first cell holder 33 and the second cell holder 34 are stacked in order from the bottom case 22 to an upper side.

The first cell holder unit 31 is configured as a honeycomb structure 36 by, for example, the first cell holder 33 and the second cell holder 34. The honeycomb structure 36 has a plurality of housing portions 37 arranged in an array. The housing portions 37 have wall 58 (which will be described below) formed in a polygonal shape when viewed, for example, in an orthogonal direction (that is, when viewed in a direction orthogonal to a bottom portion 45 which will be described below). In the embodiment, a regular hexagon is used as an example of the polygon. That is, the housing portion 37 is formed, for example, as a hollow regular hexagonal column. Note that the shape of the polygon is not limited to a regular hexagon and can be selected arbitrarily.

The housing portion 37 is disposed with its axis facing the vertical direction. The cells 32 which will be described below are housed and held in the housing portion 37. That is, the first cell holder unit 31 houses and holds the plurality of cells 32. The housing portion 37 will be described in detail below.

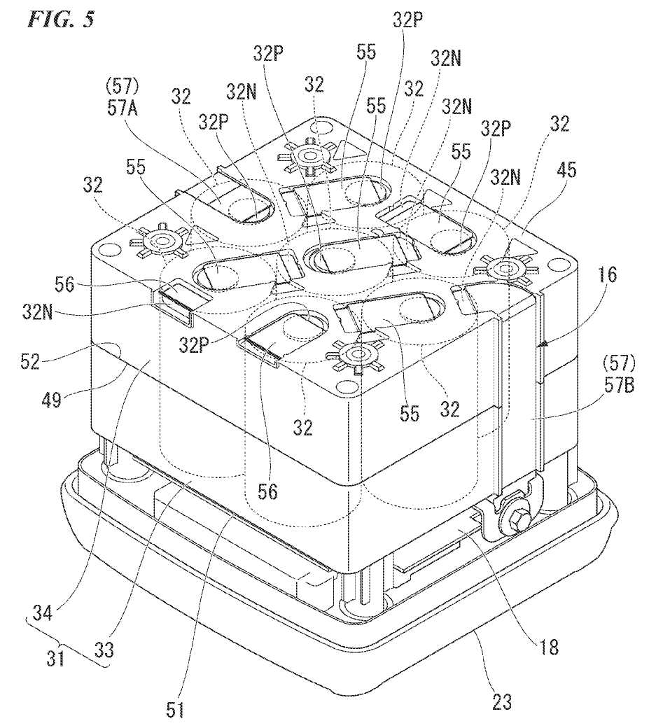

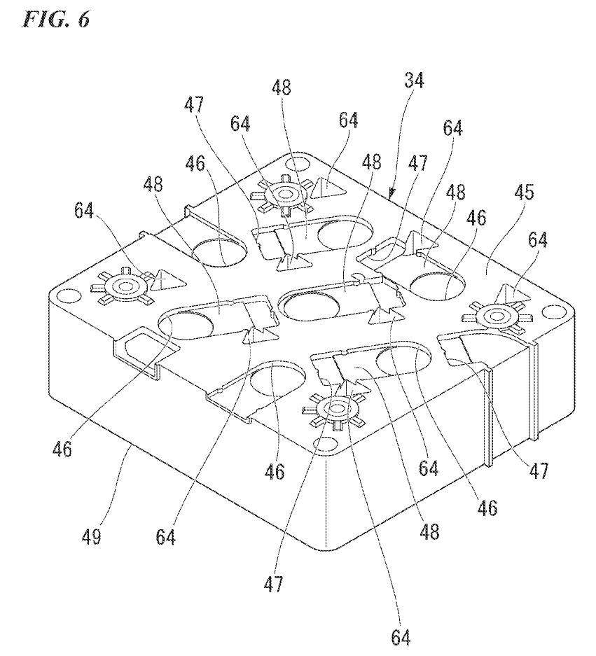

FIG. 5 is a perspective view which shows the first battery module when it is attached to the bottom case. FIG. 6 is a perspective view of a second cell holder of the first cell holder unit, as viewed from above.

As shown in FIGS. 5 and 6, the second cell holder 34 has a bottom portion 45, a positive electrode hole 46, a negative electrode hole 47, a contact portion 48, and an opening portion 49. The bottom portion 45 is formed at a top portion of the second cell holder 34.

The positive electrode hole 46 penetrates the bottom portion 45 in a thickness direction (that is, a vertical direction). The positive electrode hole 46 exposes a positive electrode terminal 32P (which will be described below) of the cell 32 in the thickness direction. The negative electrode hole 47 penetrates the bottom portion 45 in the thickness direction. The negative electrode hole 47 exposes the negative electrode terminal 32N (which will be described below) of the cell 32 in the thickness direction. The abutment portion 48 abuts against a first bus bar 55 (which will be described below). The opening portion 49 is open at a bottom of the second cell holder 34.

As shown in FIGS. 4 and 5, the first cell holder 33 has a bottom portion 51 and an opening portion 52. The bottom portion 51 is formed at a bottom of the first cell holder 33. The opening portion 52 is formed at a top of the first cell holder 33.

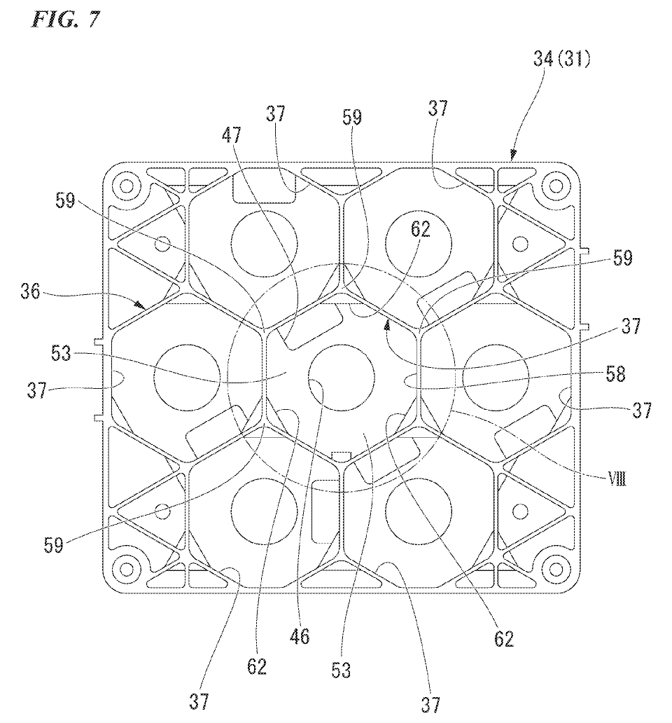

FIG. 7 is a bottom view which shows the second cell holder of the first cell holder unit.

As shown in FIGS. 3, 4 and 7, the housing portion 37 has a first bottom portion (bottom portion) 53, a second bottom portion 54, and a wall 58. The first bottom portion 53 is formed by a bottom portion 45 of the second cell holder 34. The first bottom portion 53 abuts against a first end portion 32a of the cell 32, which will be described below. The second bottom portion 54 is formed by a bottom portion 51 of the first cell holder 33. The second bottom portion 54 abuts against a second end portion 32b of the cell 32, which will be described below.

The wall 58 is formed, for example, as a hollow regular hexagonal prism. The wall 58 has, for example, a plurality of intersections 59 where the wall intersects. The wall 58 extends in the vertical direction from the first bottom portion 53 and the second bottom portion 54. The wall 58 is formed to surround the periphery of the cell 32 (which will be described below). The wall 58 has a plurality of first bulges (bulges) 62 and a plurality of second bulges 63.

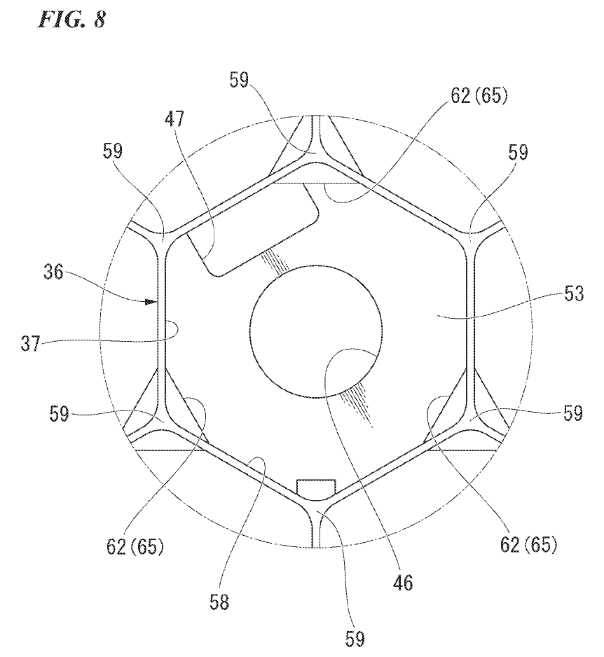

FIG. 8 is a bottom view which shows an enlarged view of VIII in the second cell holder of FIG. 7.

As shown in FIGS. 4 and 8, the plurality of first bulges 62 are formed in a ring shape that is continuous with the first bottom portion 53 of the housing portion 37. The plurality of first bulges 62 are, for example, provided at the intersections 59 at intervals of one in a circumferential direction of the wall 58 among the intersections 59. Specifically, three of the first bulges 62 are provided at the intersections 59 at intervals of one, for example, in the circumferential direction of the wall 58. The plurality of first bulges 62 are formed to bulge to an inside of the housing portion 37 and abut against a side wall of the cell 32 (which will be described below).

In the embodiment, an example in which three first bulges 62 are provided at the intersections 59 of the wall 58 as the plurality of first bulges 62 will be described, but the number of the first bulges 62 can be selected arbitrarily.

As shown in FIGS. 4 and 6, the second cell holder 34 has recessed portions 64 recessed from the bottom portion 45 side to the inside of the housing portion 37. A first bulge 62 is provided corresponding to the recessed portion 64. That is, the first bulge 62 is formed to have a surface exposed to the inside of the housing portion 37 corresponding to the recessed portion 64. A thickness of the first bulge 62 is formed to be thinner than a thickness of the first bottom portion 53 of the housing portion 37 and a portion of the wall 58 other than the first bulge 62.

In addition, the first bulge 62 has a vertical portion 65 and an inclined portion 66. The vertical portion 65 extends from the first bottom portion 53 of the housing portion 37 in a substantially perpendicular direction (that is, in a substantially axial direction of the housing portion 37). The vertical portion 65 is formed in a cylindrical (ring-like) shape. The substantially perpendicular direction also includes a perpendicular direction. The inclined portion 66 is connected from the vertical portion 65 to the portion of the wall 58 other than the first bulge 62, and has a surface that is inclined with respect to the vertical portion 65. In other words, the inclined portion 66 is formed in an annular (ring-like) shape that gradually reduces in diameter from the wall 58 to the vertical portion 65.

As shown in FIG. 4, the plurality of second bulges 63 are formed in an annular shape, which is continuous with the second bottom portion 54 of the housing portion 37. The second bulge 63 has a vertical portion 67 and an inclined portion 68, similar to the first bulge 62. The plurality of second bulges 63 are formed generally symmetrically in the vertical direction with respect to the first bulges 62. Therefore, a detailed description of the second bulges 63 will be omitted.

In this manner, the wall 58 of the housing portion 37 has the plurality of first bulges 62 that are continuous with the first bottom portion 53, and the plurality of second bulges 63 that are continuous with the second bottom portion 54. Therefore, when the cell 32 (which will be described below) is housed in the housing portion 37, the side wall of the cell 32 is held by the plurality of first bulges 62 and the plurality of second bulges 63. As a result, a portion of the wall 58 of the housing portion 37 other than the plurality of first bulges 62 and the plurality of second bulges 63 is separated from the side wall of the cell 32.

In addition, the housing portion 37 is divided into two in the vertical direction, into an upper half and a lower half, by dividing the first cell holder 33 and the second cell holder 34. The upper half of the housing portion 37 is provided in the second cell holder 34. The lower half of the housing portion 37 is provided in the first cell holder 33.

The upper half of the housing portion 37 is provided with a first bulge 62 that is continuous with the bottom portion 45 of the second cell holder 34. The upper half of the housing portion 37 is provided with an opening portion 49 on an opposite side to the first bulge 62. The lower half of the housing portion 37 is provided with a second bulge 63 that is continuous with the bottom portion 51 of the first cell holder 33. The lower half of the housing portion 37 is provided with an opening portion 52 on an opposite side to the second bulge 63.

Therefore, when the first cell holder 33 and the second cell holder 34 are assembled, the opening portion 49 of the upper half of the housing portion 37 and the opening portion 52 of the lower half of the housing portion 37 are butted together. As a result, the housing portion 37 is formed.

In the embodiment described above, an example is described in which the first bottom portion 53 of the housing portion 37 is abutted against the first end portion 32a of the cell 32, and the second bottom portion 54 of the housing portion 37 is abutted against the second end portion 32b of the cell 32, but the present invention is not limited thereto. As another example, for example, only the first bottom portion 53 of the housing portion 37 may be abutted against the first end portion 32a (that is, one end) of the cell 32. Alternatively, the second end portion 32b of the cell 32 may be used as one end, and only the second bottom portion 54 of the housing portion 37 may be abutted against the second end portion 32b.

As shown in FIGS. 3 and 4, the cell 32 is disposed (housed) in the vertical direction along an axial direction of the housing portion 37 inside the housing portion 37. The cell 32 is formed in a cylindrical shape. The cell 32 includes a first end (one end) 32a, a second end 32b, a positive electrode terminal 32P, and a negative electrode terminal 32N. The first end 32a and the second end 32b are provided at both ends in the vertical direction.

Specifically, the first end 32a is provided at an upper end of the cell 32. The second end 32b is provided at a lower end of the cell 32. Therefore, the plurality of cells 32 are disposed along a predetermined surface with orientations of the first end 32a and the second end 32b aligned. The positive electrode terminal 32P and the negative electrode terminal 32N are disposed (provided) on a first end 32a side.

That is, the positive electrode terminal 32P and the negative electrode terminal 32N are formed on the upper side of the cell 32. Therefore, when the cells 32 are arranged in a planar direction, the positive electrode terminal 32P and the negative electrode terminal 32N are provided on the upper side of the cells 32. The positive electrode terminal 32P protrudes upward from the negative electrode terminal 32N and is positioned above the negative electrode terminal 32N in the orthogonal direction.

The positive electrode terminal 32P is exposed to an outside of the second cell holder 34 through the positive electrode hole 46 (refer to FIG. 6). The negative electrode terminal 32N is exposed to the outside of the second cell holder 34 through the negative electrode hole 47 (refer to FIG. 6).

As shown in FIG. 1 and FIG. 2, the second battery module 26 is stacked on the upper side of the first battery module 25. The first battery module 25 and the second battery module 26 are formed, for example, generally symmetrically in the vertical direction. The second battery module 26 includes, for example, a second cell holder unit (cell holder) 42 and a plurality of cells 32. The second cell holder unit 42 includes a third cell holder 43 and a fourth cell holder 44. In the second cell holder unit 42, the third cell holder 43 and the fourth cell holder 44 are stacked in order from the top case 21 downward.

As shown in FIGS. 2 and 7, the second cell holder unit 42 has a plurality of housing portions (not shown) similar to the first battery module 25. The cells 32 are housed and held in the housing portion of the second cell holder unit 42 similar to the housing portion 37 of the first cell holder unit 31. That is, the second cell holder unit 42 houses and holds the plurality of cells 32 similar to the first battery module 25. The plurality of cells 32 housed in the second cell holder unit 42 are disposed along a predetermined plane with orientations of the first end portion 32a and the second end portion 32b aligned. The plurality of cells 32 housed in the second cell holder unit 42 are disposed with the first end portion 32a on the lower side.

In the embodiment, the first battery module 25 and the second battery module 26 are used as an example of the battery module unit 14, but the number of battery modules can be selected arbitrarily.

### Bus bar unit

As shown in FIGS. 2 and 5, the bus bar unit 16 is provided in the first battery module 25 and the second battery module 26 (refer to FIG. 2). The bus bar unit 16 includes a plurality of first bus bars 55, a plurality of second bus bars 56, and a plurality of third bus bars 57.

In the embodiment, for example, two second bus bars 56 will be described as an example of the plurality of second bus bars 56. The number of second bus bars 56 can be selected arbitrarily according to the number of first battery modules 25 and second battery modules 26. Furthermore, for example, two third bus bars 57 will be described as an example of the plurality of third bus bars 57. The number of third bus bars 57 can be selected arbitrarily according to the number of control units 18 (described below).

The plurality of first bus bars 55 are included in the first battery module 25 and the second battery module 26. The first bus bar 55 of the first battery module 25 electrically connects the plurality of cells 32 included in the first battery module 25. Hereinafter, “electrically connect” may be referred to as “connect.”

The plurality of first bus bars 55 connect an electrode of one cell 32 to an electrode of another cell 32 adjacent to the one cell 32 in the first battery module 25.

The electrode of one cell 32 is one of electrodes of the positive electrode terminal 32P and the negative electrode terminal 32N of the one cell 32. The electrode of the other cell 32 is an electrode of the other of the positive electrode terminal 32P and the negative electrode terminal 32N of the other cell 32. In other words, the first bus bar 55 electrically connects adjacent cells 32 to each other.

In addition, in the second battery module 26, the plurality of first bus bars 55 electrically connect adjacent cells 32 to each other, similar to the first battery module 25.

The two second bus bars 56 electrically connect, for example, the cell 32 of the first battery module 25 and the cell 32 of the second battery module 26. Here, the positive electrode terminal 32P and a negative electrode terminal 32N of the cell 32 in the first battery module 25 and the positive electrode terminal 32P and the negative electrode terminal 32N of the cell 32 in the second battery module 26 are disposed at, for example, positions facing each other in the vertical direction.

In this state, one of the two second bus bars 56 is connected to, for example, a positive electrode terminal 32P of the cell 32 in the first battery module 25. Moreover, one of the second bus bars 56 is connected to, for example, the negative electrode terminal 32N of the cell 32 in the second battery module 26. Furthermore, the other of the two second bus bars 56 is connected to, for example, the negative electrode terminal 32N of the cell 32 in the first battery module 25. The other second bus bar 56 is connected to the positive electrode terminal 32P of the cell 32 in the second battery module 26.

Therefore, the cell 32 of the first battery module 25 and the cell 32 of the second battery module 26 are electrically connected to each other by the two second bus bars 56.

The two third bus bars 57 electrically connect the first battery module 25 and the second battery module 26 to the control unit 18 (described below). The two third bus bars 57 are configured from a positive electrode bus bar 57A and a negative electrode bus bar 57B. Here, the control unit 18 is disposed on a lower side of the first battery module 25.

In this state, the positive electrode bus bar 57A connects the positive electrode terminal 32P of the cell 32 in the first battery module 25 to a positive electrode terminal (not shown) of the control unit 18. The negative electrode bus bar 57B connects the negative electrode terminal 32N of the cell 32 in the second battery module 26 to a negative electrode terminal (not shown) of the control unit 18.

Here, the cell 32 of the first battery module 25 and the cell 32 of the second battery module 26 are electrically connected by two second bus bars 56. Therefore, the cell 32 of the first battery module 25 and the cell 32 of the second battery module 26 are electrically connected to the control unit 18 by the positive electrode bus bar 57A and the negative electrode bus bar 57B.

### Control unit

The control unit 18 is disposed on the lower side of the first battery module 25. The control unit 18 is, for example, a so-called battery management unit (BMU). The control unit 18 monitors and controls states of the cell 32 of the first battery module 25 and the cell 32 of the second battery module 26. The control unit 18 is, for example, a software function unit that functions by a processor such as a central processing unit (CPU) executing a predetermined program.

The software function unit is an electronic control unit (ECU) that includes a processor such as a CPU, a read only memory (ROM) that stores a program, a random access memory (RAM) that temporarily stores data, and electronic circuits such as a timer. At least a part of the control unit 18 may be an integrated circuit such as large scale integration (LSI).

The control unit 18 includes, for example, various sensors that detect states of the cell 32 of the first battery module 25 and the cell 32 of the second battery module 26, and a storage unit that stores information on the battery 10, a predetermined program, and the like.

The states of the cells 32 of the first battery module 25 and the cells 32 of the second battery module 26 are, for example, a voltage, a current, a temperature, and the like. The information on the battery 10 includes, for example, identification information such as a battery ID (IDentifier) exclusively assigned to the battery 10, information on the states of the cells 32 based on a manufacturing date and time, an initial state capacity, an output of a sensor, and the like, charge and discharge history, storage time in a replacement unit, and usage pattern history.

According to the battery 10 according to the embodiment described above, the following actions and effects can be obtained. The first battery module 25 and the second battery module 26 are formed generally symmetrically in the vertical direction. Therefore, the following describes the first battery module 25, and description of the second battery module 26 will be omitted.

As shown in FIG. 4, in the first cell holder unit 31, lower halves of the plurality of housing portions 37 are provided in the first cell holder 33, and upper halves of the plurality of housing portions 37 are provided in the second cell holder 34. In the upper halves of the plurality of housing portions 37, a first bulge 62 is provided in the wall 58 to be continuous with the first bottom portion 53 of the housing portion 37. In addition, an opening portion 49 is provided on the opposite side to the first bulge 62 in the upper halves of the plurality of housing portions 37. Therefore, for example, when the second cell holder 34 is molded, the mold can be closed and opened in the vertical direction along the axial direction of the housing portion 37 using the first bulge 62 as a reference. As a result, the first bulge 62 can be easily molded in the wall 58 in the upper half of the housing portion 37.

In addition, in the lower halves of the plurality of housing portions 37, the second bulge 63 is provided in the wall 58 to be continuous with the second bottom portion 54. Moreover, in the lower halves of the plurality of housing portions 37, the opening portion 52 is provided on the opposite side to the second bulge 63. Therefore, for example, when the first cell holder 33 is molded, the mold can be closed and opened in the vertical direction using the second bulge 63 as a reference. As a result, the second bulge 63 can be easily molded in the wall 58 in the lower half of the housing portion 37.

Here, when the first cell holder 33 and the second cell holder 34 are assembled, the opening portion 49 of the upper half of the housing portion 37 and the opening portion 52 of the lower half of the housing portion 37 are butted together. As a result, the housing portion 37 is formed. Therefore, the first cell holder unit 31 can be easily molded.

Moreover, the recessed portion 64 is provided in the bottom portion 45 of the second cell holder 34, and the first bulge 62 is exposed to the inside of the housing portion 37 corresponding to the recessed portion 64. Therefore, the thickness of the first bulge 62 can be made thin. Furthermore, in the second cell holder 34, a thickness of the second bulge 63 can be made thin in the same manner as the first bulge 62. As a result, when the cell 32 is inserted toward the first bulge 62 and the second bulge 63 inside the housing portion 37, the first bulge 62 and the second bulge 63 can be deformed to match the shape of the cell 32. Therefore, the cell 32 can be held with an appropriate pressure.

Furthermore, the thicknesses of the first bulge 62 and the second bulge 63 in the housing portion 37 are made thinner than the thicknesses of the first bottom portion 53, the second bottom portion 54, and the wall 58. Therefore, when the cell 32 is inserted toward the first bulge 62 and the second bulge 63 inside the housing portion 37, the first bulge 62 and the second bulge 63 can be deformed more easily. As a result, the cell 32 can be held with an even more appropriate pressure.

In addition, when the cell 32 is housed in the housing portion 37, the side wall of the cell 32 is held by the first bulge 62 and the second bulge 63. Therefore, the portion of the wall 58 of the housing portion 37 other than the first bulge 62 and the second bulge 63 can be kept separated from the side wall of the cell 32. This allows an air layer to be secured between the portion of the wall 58 of the housing portion 37 other than the first bulge 62 and the second bulge 63 and the side wall of the cell 32.

As a result, a portion of the side wall of the cell 32 that does not abut against the first bulge 62 and the second bulge 63 can be brought to be adjacent to an adjacent housing portion 37 via the air layer. This prevents heat generated in the cell 32 from being transmitted to the adjacent housing portion 37.

Furthermore, the first bulge 62 has an inclined portion 66, which is set to a surface that is inclined relative to the vertical portion 65. The second bulge 63 has an inclined portion 68, which is set to a surface that is inclined relative to the vertical portion 67. Therefore, when the cell 32 is housed inside the housing portion 37, the cell 32 can be moved to the inside of the vertical portion 65 of the first bulge 62 and the vertical portion 67 of the second bulge 63 while being abutted against (being brought into contact with) the inclined portion 66 of the first bulge 62 and the inclined portion 68 of the second bulge 63. As a result, the cell 32 can be easily inserted into the housing portion 37 while preventing the cell 32 from strongly interfering with the first bulge 62 and the second bulge 63.

A technical scope of the present invention is not limited to the embodiment described above, and various modifications can be made within a range not departing from the gist of the present invention.

In addition, components in the embodiment described above can be replaced with well-known components as appropriate within a range not departing from the gist of the present invention, and the modified examples described above can be combined as appropriate.

### BRIEF DESCRIPTION OF THE REFERENCE SYMBOLS

1 Battery

31 First cell holder unit (Cell holder)

32 Cell

32a First end portion (one end)

37 Housing portion

42 Second cell holder unit (Cell holder)

53 First bottom portion (Bottom portion)

54 Second bottom portion

58 Wall

59 Intersection

62 First bulge (Bulge)

63 Second bulge

64 Recessed portion

65, 67 Vertical portion

66, 68 Inclined portion

What is claimed is:

1. A battery comprising:
a cell and
a cell holder having a plurality of housing portions for housing the cell,
wherein the housing portion has a bottom portion abutting one end of the cell and a wall surrounding a periphery of the cell, and
the wall has a formed bulge that is continuous with the bottom portion and bulges to an inside of the housing portion to abut against a side wall of the cell.

2. The battery according to claim 1,
wherein the cell holder has a recessed portion recessed from a bottom portion side into the housing portion, and
the bulge is formed of a surface exposed to an inside of the housing portion corresponding to the recessed portion.

3. The battery according to claim 2,
wherein a thickness of the bulge is thinner than a thickness of the bottom portion and a portion of the wall other than the bulge.

4. The battery according to claim 1,
wherein the cell is cylindrical,
when viewed in a direction orthogonal to the bottom portion, the wall has a polygonal shape,
the bulge is formed at an intersection where the wall intersects, and
a portion of the wall other than the bulge is separated from a side wall of the cell.

5. The battery according to claim 1,
wherein the bulge has a vertical portion extending in a substantially perpendicular direction from the bottom portion, and
an inclined portion that connects from the vertical portion to a portion of the wall other than the bulge and has a surface inclined with respect to the vertical portion.
